(19) United States
(12) Patent Application Publication
(10) Pub. No.: US 2012/0209606 A1
(43) Pub. Date: Aug. 16, 2012

(54) METHOD AND APPARATUS FOR INFORMATION EXTRACTION FROM INTERACTIONS

(75) Inventors: Maya Gorodetsky, Modiin (IL); Ezra Daya, Petah-Tikwah (IL); Oren Pereg, Amikam (IL)

(73) Assignee: Nice Systems Ltd., Ra'anana (IL)

(21) Appl. No.: 13/026,319

(22) Filed: Feb. 14, 2011

(51) Int. Cl. G10L 15/26; G10L 15/00

(52) U.S. Cl. 704/235; 704/239; 704/E15.001; 704/E15.043

(57) ABSTRACT

Obtaining information from audio interactions associated with an organization. The information may comprise entities, relations or events. The method comprises: receiving a corpus comprising audio interactions; performing audio analysis on audio interactions of the corpus to obtain text documents; performing linguistic analysis of the text documents; matching the text documents with one or more rules to obtain one or more matches; and unifying or filtering the matches.

### TECHNICAL FIELD

The present disclosure relates to interaction analysis in general, and to a method and apparatus for information extraction from automatic transcripts of interactions, in particular.

### BACKGROUND

Large organizations, such as commercial organizations, financial organizations or public safety organizations conduct numerous interactions with customers, users, suppliers or other persons on a daily basis. A large part of these interactions are vocal, or at least comprise a vocal component, while others may include text in various formats such as e-mails, chats, accesses through the web or others.

These interactions can provide significant insight into some of the most important sources of information and thus to issues bothering the organization's clients and other affiliates. The interactions may comprise information related, for example, to entities such as companies, products, or service names; relations such as “person X is an employee of company Y”, or “company X sells product “Y””; or events, such as a customer churning a company, customer dissatisfaction with a service, and optionally possible reasons for such events, or the like.

Thus, obtaining information by exploration of interactions, including vocal interactions, can provide business insights from users' interactions in a call center, including entities such as products names, competitors, customers, or the like, relations and events such as why a customer wants to leave the company, what the main problems encountered by customers are, or the like.

The tedious task of uncovering the issues raised by customers in a call center is currently carried out manually by humans listening to calls and reading textual interactions of the call center. It is therefore required to automate this process.

Speech-to-text (S2T) technologies, used for producing automatic texts from audio signals have made significant advances, and currently text can be extracted from vocal interactions, such as but not limited to phone interactions, with higher accuracy and detection level than before, meaning that many of the words appearing in the transcription were indeed said in the interaction (precision), and that a high percentage of the said words appear in the transcription (recall rate).

Once the precision and recall are high enough, such transcripts can be a source of important information. However, there are a number of factors limiting the ability to extract useful information, which are unique to vocal interactions.

First, despite the improvements in speech to text technologies, the word error rate of automatic transcription may still be high, particularly in interactions of low audio quality.

Second, the required information may be scattered in different locations throughout the interaction and throughout the text, rather than in a continuous sentence or paragraph.

Even further, the required information may be embedded in a dialogue between two speakers. For example, the agent may ask “why do you wish to cancel the service”, and the customer may answer “because it is too slow”, and may even provide such answer after some intermediate sentences. Thus, the complete event may be dispersed between two or more speakers.

There is thus a need in the art for automatically extracting information which may comprise entities, relations, or events from interactions and vocal interactions in particular.

### SUMMARY

A method and apparatus for obtaining information from audio interactions associated with an organization.

A first aspect of the disclosure relates to a method for obtaining information from audio interactions associated with an organization, comprising: receiving a corpus comprising audio interactions; performing audio analysis on one or more audio interactions of the corpus to obtain one or more text documents; performing linguistic analysis on the text documents; matching one or more of the text documents with one or more rules to obtain one or more matches; and unifying or filtering one or more of the matches. Within the method, one or more of the rules may comprise a pattern containing one or more elements. Within the method, the pattern may comprise one or more operators. The method can further comprise generating the rules. Within the method, generating the rules optionally comprises: defining each rule; expanding the rule; and setting a score for a token within the rule or to the rule. Within the method, the audio analysis optionally comprises performing speech to text of the audio interactions. Within the method, the audio analysis optionally comprises one or more items selected from the group consisting of: word spotting of an audio interaction; call flow analysis of an audio interaction; talk analysis of an audio interaction; and emotion detection in an audio interaction. Within the method, the linguistic analysis optionally comprises one or more items selected from the group consisting of: part of speech tagging; and word stemming. Within the method, matching the rules optionally comprises assigning a score to each of the matches. The method can further comprise visualizing the at matches. The method can further comprise capturing the audio interactions. Within the method, matching the rules optionally comprises pattern matching.

Another aspect of the disclosure relates to an apparatus for obtaining information from audio interactions associated with an organization, comprising: an audio analysis engine for analyzing one or more audio interactions from a corpus and obtaining one or more text documents; a linguistic analysis engine for processing the text documents; a rule matching component for matching the text documents with one or more rules to obtain one or more matches; and a unification and filtering component for unifying or filtering the matches. Within the apparatus, the audio analysis engines optionally comprise: a speech to text engine, a word spotting engine; a call flow analysis engine; a talk analysis engine; or an emotion detection engine. Within the apparatus, the each rule optionally comprises a pattern containing one or more elements, and at one or more operators. The apparatus can further comprise rule generation components for generating the rules. Within the apparatus, the rule generation component optionally comprises: a rule definition component for defining a rule; a rule expansion component for expanding the rule; and a score setting component for setting a score for a token within the rule or to the rule. The apparatus of can further comprise a user interface component for visualizing the matches. The apparatus can further comprise a capturing or logging component for capturing or logging the audio interactions.

Yet another aspect of the disclosure relates to a computer readable storage medium containing a set of instructions for a general purpose computer, the set of instructions comprising: receiving a corpus comprising audio interactions associated with an organization; performing audio analysis on at audio interaction of the corpus to obtain a text document; performing linguistic analysis on the text document; matching the text document with a rule to obtain a match; and unifying or filtering the match.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is an illustrative representation of a rule for identifying an event, in accordance with the disclosure;

FIG. 2 is a block diagram of the main components in an apparatus for exploration of audio interactions, and in a typical environment in which the method and apparatus are used, in accordance with the disclosure;

FIG. 3 is a schematic flowchart detailing the main steps in a method for information extraction from interactions, in accordance with the disclosure; and

FIG. 4 is an exemplary embodiment of an apparatus for information extraction from interactions, in accordance with the disclosure.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter relates to automating the process of obtaining information such as entities, relations and events from vocal interactions. The process is currently time consuming and human labor intensive.

Technical aspects of the solution can relate to an apparatus and method for capturing interactions from various sources and channels, transcribing the vocal interactions, and further processing the transcriptions and optionally additional textual information sources, to obtain insights into the organization's activities and issues discussed in interactions. The transcribing may be operated on summed audio, which carries the voices of the two sides of a conversation. In other embodiments, each side can be recorded and transcribed separately, and the resulting text can be unified, using time tags attached to at least some of the transcribed words. The textual analysis may comprise Linguistic, followed by matching the resulting text to predetermined rules. One or more rules can describe how a name of an entity, a relation or an event can be identified.

A rule can be represented as a pattern containing elements and optionally operators applied to the elements. The elements may be particular strings, lexicons, parts of Speech, or the like, and the operators may be “near” with optional parameter indicating the distance between two tokens, “or”, “optional”, or others. A rule can also contain logical constraints which should be met by the pattern elements. The constraints allow improving the results matched by the pattern while preserving the compactness of the pattern expression.

In some embodiments, the rules can be implemented on top of an indexing system. In such embodiments, the received texts are indexed, and the words and terms are stored in an efficient manner. Additional data may be stored as well, for example part of speech information. The rules can then be defined and implemented as a layer which uses the indexing system and its abilities. This implementation enables efficient search for patterns in the text using the underlying information retrieval system

In other embodiments, the rules can be expressed as regular expressions and in particular token-level expressions, and matching the text to the rules can be performed using regular expression matching. In yet other alternatives, rules can be expressed as patterns, and matching can use any known method for pattern matching.

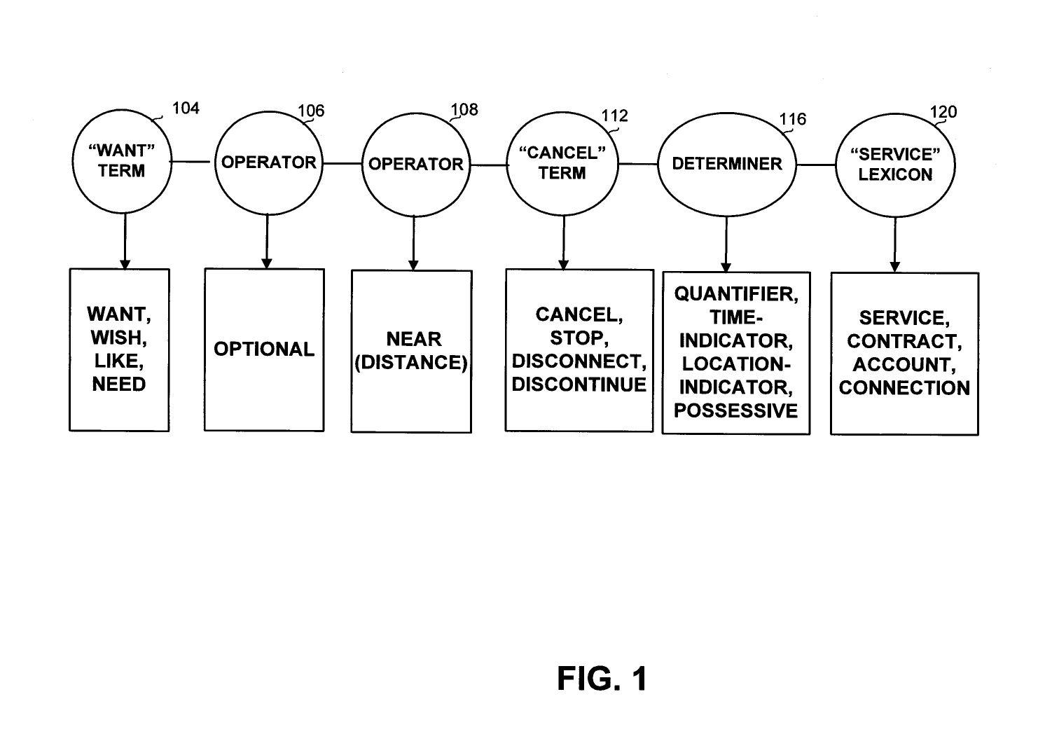

Referring now to FIG. 1, showing an example of a rule describing events conveying the wish of a customer to quit a program such as “I'd like to terminate the contract”, “I want to go ahead and cancel my account”, “I want to stop the service”, or the like.

A “Want” term lexicon token 104, is followed by an operator 106 indicating that the term is optional, and a further operator 108 indicating for example a maximal or minimal distance for example in words, between the preceding and following terms, and further followed by a “cancel” lexicon term token 112, a modifier token 116, and a “service” lexicon term token 120.

“Want” term lexicon token 204 is a word or phrase from a predetermined group of words indicating words similar in meaning to “want”, such as “want”, “wish”, “like”, “need”, or others.

Operator 108 is an indicator related to the distance between two tokens. Thus, operator 108 can indicate that a maximal or minimal distance is required between the two tokens.

“Cancel” term lexicon token 212 is a word or phrase from a predetermined group of words indicating words similar in meaning to “cancel”, such as “cancel”, “stop”, “disconnect”, “discontinue”, or others.

Determiner 216 indicates a word or term of one or more specific parts of speech, such as a quantifier: “all”, “several”, or others; a possessive such as “my”, “your”, or the like, or other parts of speech.

“Service” term lexicon token 220 is a word or phrase from a predetermined group of words indicating words similar in meaning to “service”, such as “service”, “contract”, “account”, “connection”, or others. These words may be related to the type of products or services provided by the organization. Thus, some of the lexicons may be general and required by any organization, while others are specific to the organization's domain.

Each of the word terms, such as “want” lexicon and others can be fuzzily searched in a phonetic manner. For example, a word recognized as “won't” can also be matched, although with lesser certainty, where the word “want” can be matched.

Each pattern or part thereof is assigned a score, which reflects a confidence degree that the matched phrase expresses the desired event. In some embodiments a score of a pattern may be combined of any one or more of the following components: words confidence score for one or more words in the pattern, for example the word “cancel” is more probable to express a customer churn intention than the word “stop”; phonetic similarity score indicating the similarity between the pattern word and the word recognized in the automatic transcription; and a pattern confidence score which expresses a pattern confidence.

Once entities, relations and events have been determined in interactions within a corpus, unification and filtering may be performed, which unifies the results obtained per single interactions, for the entire corpus, and filters out information which is of little value.

The results can be visualized or otherwise output to a user. In some embodiments, the user can enhance, add, delete, correct or otherwise manipulate the results of any of the stages, or import additional information from other systems.

The method and apparatus enable the derivation and extraction of descriptive and informative topics from a collection of automatic transcripts, the topics reflecting common or important issues of the input data set. The extraction enables a user to explore relations and associations between objects and events expressed in the input data, and to apply convenient visualization of graphs for presenting the results. The method and apparatus further enable the grouping of interactions complying with the same rules, in order to gain more insight into the common problems.

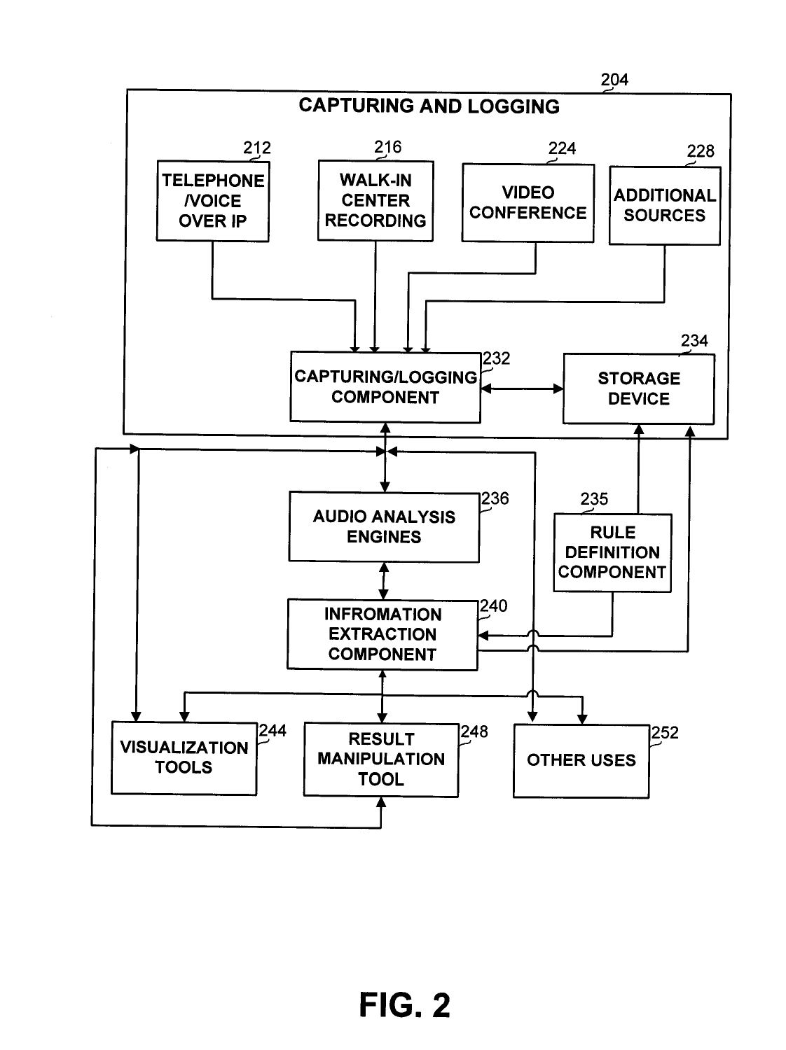

Referring now to FIG. 2, showing a block diagram of the main components in an exemplary embodiment of an apparatus for exploration of audio interactions, and in a typical environment in which the method and apparatus are used. The environment is preferably an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Segments, including broadcasts, interactions with customers, users, organization members, suppliers or other parties are captured, thus generating input information of various types. The information types optionally include auditory segments, video segments, textual interactions, and additional data. The capturing of voice interactions, or the vocal part of other interactions, such as video, can employ many forms, formats, and technologies, including trunk side recording, extension side recording, summed audio, separate audio, various encoding and decoding protocols such as G729, G726, G723.1, and the like.

The interactions are captured using capturing or logging components 204. The vocal interactions are usually captured using telephone or voice over IP session capturing component 212.

Telephone of any kind, including landline, mobile, satellite phone or others is currently a main channel for communicating with users, colleagues, suppliers, customers and others in many organizations. The voice typically passes through a PABX (not shown), which in addition to the voice of one, two, or more sides participating in the interaction collects additional information discussed below. A typical environment can further comprise voice over IP channels, which possibly pass through a voice over IP server (not shown). It will be appreciated that voice messages or conference calls are optionally captured and processed as well, such that handling is not limited to two-sided conversations. The interactions can further include face-to-face interactions which may be recorded in a walk-in-center by walk-in center recording component 216, video conferences comprising an audio component which may be recorded by a video conference recording component 224, and additional sources 228. Additional sources 228 may include vocal sources such as microphone, intercom, vocal input by external systems, broadcasts, files, streams, or any other source. Additional sources 228 may also include non-vocal and in particular textual sources such as e-mails, chat sessions, facsimiles which may be processed by Object Character Recognition (OCR) systems, or others, information from Computer-Telephony-Integration (CTI) systems, information from Customer-Relationship-Management (CRM) systems, or the like. Additional sources 228 can also comprise relevant information from the agent's screen, such as screen events sessions, which comprise events occurring on the agent's desktop such as entered text, typing into fields, activating controls, or any other data which may be structured and stored as a collection of screen occurrences, or alternatively as screen captures.

Data from all the above-mentioned sources and others is captured and may be logged by capturing/logging component 232. Capturing/logging component 232 comprises a computing platform executing one or more computer applications as detailed below. The captured data may be stored in storage 234 which is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured segments and different types of additional data. The storage can be located onsite where the segments or some of them are captured, or in a remote location. The capturing or the storage components can serve one or more sites of a multi-site organization. Storage 234 may also contain data and programs relevant for audio analysis, such as speech models, speaker models, language models, lists of words to be spotted, or the like.

Audio analysis engines 236 receive vocal data of one or more interactions and process it using audio analysis tools, such as speech-to-text (S2T) engine which provides continuous text of an interaction, a word spotting engine which searches for particular words said in an interaction, emotion analysis, or the like. The audio analysis can depend on data additional to the interaction itself. For example, depending on the number called by a customer, which may be available through CTI information, a particular list of words can be spotted, which relates to the subjects handled by the department associated with the called number.

The operation and output of one or more engines can be combined, for example by incorporating spotted words, which generally have higher confidence than words found by general-purpose S2T process, into the text output by an S2T engine; searching for words expressing anger in areas of the interaction in which high levels of emotion have been identified, and incorporating such spotted words into the transcription, or the like.

The output of audio analysis engines 236 is thus a corpus of texts related to interactions, such as textual representations of one or more vocal interactions, as well as interactions which are a-priori textual, such as e-mails, chat sessions, text entered by an agent and captured as a screen event, or the like.

If the interactions are recorded as summed, i.e., as an audio signal carrying the voices of the two sides of the interaction, then transcribing the audio will provide the continuous text of the two participants. If, on the other hand, each side is recorded separately, then each side may be transcribed separately thus receiving higher quality transcription. The two transcriptions are then combined, using time tags attached to each word within the transcription, or at least to some of the words. It will be appreciated that single-side capturing and transcription may provide text of higher quality and lower error rate, but an additional step of combining the transcriptions is required.

Once the textual representation of one or more interactions is available, it is passed to information extraction component 240.

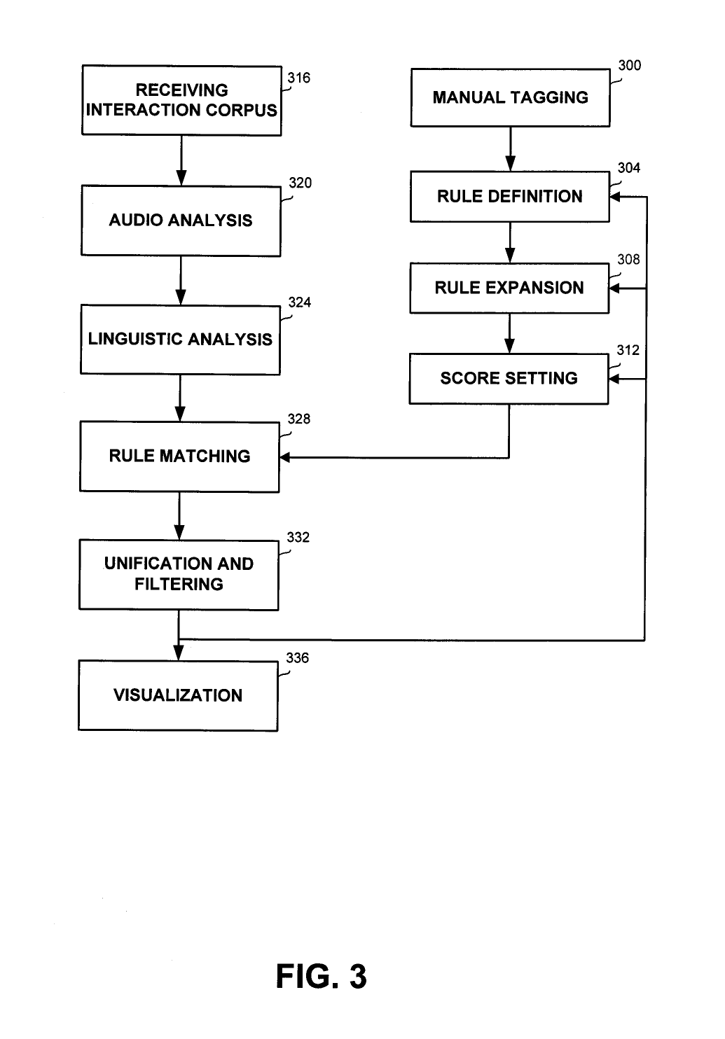

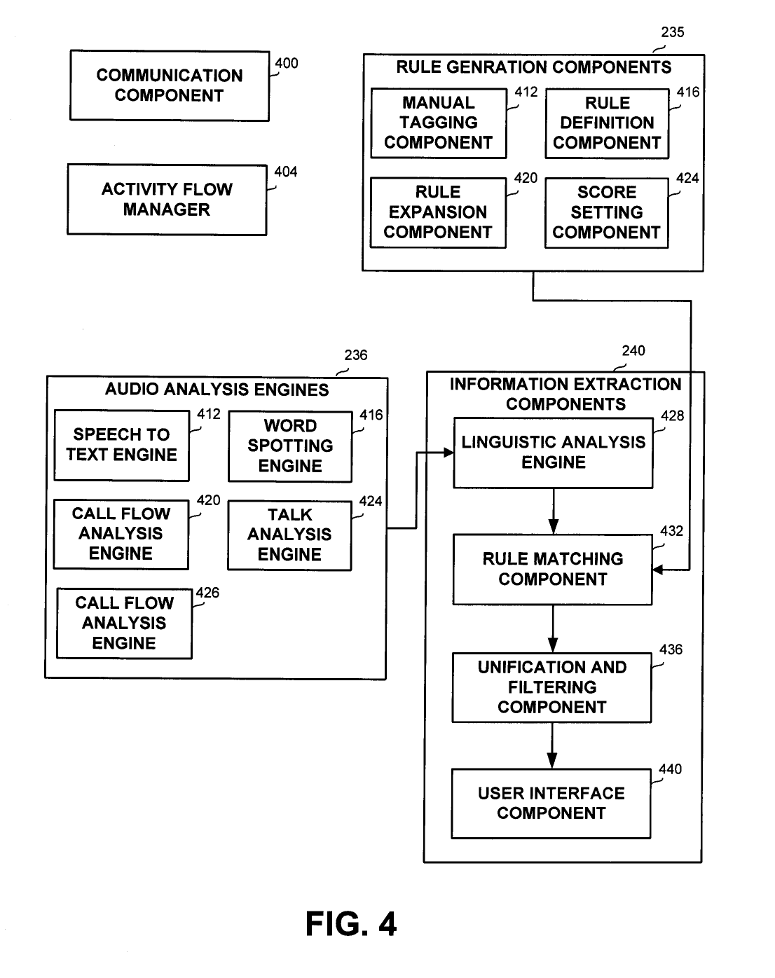

Information extraction components 240 process the textual representation of the interactions, to obtain entities, relations, or events within the transcriptions, which may be relevant for the organization. The information extraction is further detailed in association with FIG. 3 and FIG. 4 below.

Information extraction component 240 receives also the rules, as defined by rule definition component 235. Rule definition component 235 provides a user or a developer provided with tools for defining the rules for identifying entities, relations and events.

The output of audio analysis engines 236 or information extraction components 240, as well as the rules defined using rule definition component 235, can be stored in storage device 234 or any other storage device, together or separately from the captured or logged interactions.

The results of information extraction components 240 can then be passed to any one of a multiplicity of uses, such as but not limited to visualization tools 244 which may be dedicated, proprietary, third party or generally available tools, result manipulation tools 248 which may be combined or separate from visualization tools 244, and which enable a user to change, add, delete or otherwise manipulate the results of information extraction components 240. The results can also be output to any other uses 252, which may include statistics, reporting, alert generation when a particular event becomes more or less frequent, or the like.

Any of visualization tools 244, result manipulation tools 248 or other uses 252 can also receive the raw interactions or their textual representation as stored in storage device 234. The output of visualization tools 244, result manipulation tools 248 or other uses 252, particularly if changed for example by result manipulation tools 248, can be fed back into information extraction components 240 to enhance future extraction.

In some embodiments, the audio interactions may be streamed to audio analysis engines 236 and analyzed as they are being received. In other embodiments, the audio may be received as complete files, or as one or more chunks, for example 2-30 seconds chunk, such as 10 seconds chunks.

In some embodiments, all interactions undergo the analysis while in other embodiments only specific interactions are processed, for example interactions having a length between a minimum value and a maximum value, interactions received from VIP customers, or the like.

It will be appreciated that different, fewer or additional components can be used for various organizations and environments. Some components can be unified, while the activity of other described components can be split among multiple components. It will also be appreciated that some implementation components, such as process flow components, storage management components, user and security administration components, audio enhancement components, audio quality assurance components or others can be used.

The apparatus may comprise one or more computing platforms, executing components for carrying out the disclosed steps. Each computing platform can be a general purpose computer such as a personal computer, a mainframe computer, or any other type of computing platform that is provisioned with a memory device (not shown), a CPU or microprocessor device, and several I/O ports (not shown). The components are preferably components comprising one or more collections of computer instructions, such as libraries, executables, modules, or the like, programmed in any programming language such as C, C++, C#, Java or others, and developed under any development environment, such as .Net, J2EE or others. Alternatively, the apparatus and methods can be implemented as firmware ported for a specific processor such as digital signal processor (DSP) or microcontrollers, or can be implemented as hardware or configurable hardware such as field programmable gate array (FPGA) or application specific integrated circuit (ASIC). The software components can be executed on one platform or on multiple platforms wherein data can be transferred from one computing platform to another via a communication channel, such as the Internet, Intranet, Local area network (LAN), wide area network (WAN), or via a device such as CDROM, disk on key, portable disk or others.

Referring now to FIG. 3, showing a schematic flowchart detailing the main steps in a method for data exploration of automatic transcripts being executed by 235, 236 and 240 of FIG. 2.

FIG. 3 shows two main stages—a preparatory stage of constructing the rules and scores, and a runtime stage at which the rules and scores are used to identify entities, relations, events or other issues or topics within interactions.

The preparatory stage optionally comprises manual tagging 300, at which entities, relations, events or other topics or issues are identified in training interactions, possibly by a human listener.

Once the instances of the desired entities, relations or events are identified, rules are defined on 304 which describe some or all of the identified instances. Rules may be comprised of lexicon terms, i.e., a collection of words having a similar meaning, particular strings, parts of speech, or operators operating on a single element or on two or more elements as shown in association with FIG. 1 above.

On 308, the rules are expanded using automatic expansion tools. For example, a rule can be expanded by adding semantic information such as enabling the identification of synonyms to words appearing in the initially created rules, by syntactic paraphrasing, or the like.

On 312, scores are assigned to the rules and parts thereof, for example a word confidence score is attached to each word in a pattern. A phonetic similarity score may be attached to pairs comprising a word in a pattern and a word that sounds similar, for example the pair of “cancel” and “council” will receive a higher similarity score than the pair comprising “cancel” and “pencil”. Also assigned is a pattern score, which provides a score setting for the whole pattern. For example, a pattern consisting of one or two components will generally be assigned a lower score than a longer pattern, since it is easier to mistakenly assign the shorter pattern to a part of an interaction, and since it is generally less safe, i.e., more probable not to express the desired entity, relation, or event). For example, “I'd like to cancel the account” is more likely to express the customer churn intention than only “cancel the account” which may refer to general terms of cancellation that an agent explains to a customer.

Steps 300, 304, 308 and 312 are preparatory steps, and their output is a set of rules or patterns which can be used for identifying entities, relations or events within a corpus of captured interactions. Step 300 can be omitted if the rules are defined by people who are aware of the common usage of the desired entities, relations and events and the language diversity (lexical and syntactic paraphrasing). In some embodiments, only initial rules can be defined on step 304, wherein steps 308 and 312 are replaced or enhanced by results obtained from captured interactions during runtime.

On 316, a corpus comprising one or more audio interactions is received. Each interaction can contain one or more sides of a phone conversation taken over any type of phone including voice over IP, a recorded message, a vocal part of a video capture, or the like. In some embodiments, the corpus can be received by capturing and logging the interactions using suitable capture devices.

On 320, audio analysis is performed over the received interactions, including for example speech to text, word spotting, emotion analysis, call flow analysis, talk analysis, or the like. Call flow analysis can provide for example the number of transfers, holds, or the like. Talk analysis can provide the periods of silence on either side or on both sides, talk over periods, or the like.

The operation and output of one or more engines can be combined, for example by incorporating spotted words, which generally have higher confidence than words spotted by a general S2T process, into the text output by an S2T engine; searching for words expressing anger in areas of the interaction having high levels of emotion and incorporating such spotted words into the transcription, or the like.

The operation and output of one or more engines can also depend on external information, such as CTI information, CRM information or the like. For example, calls by VIP customers can undergo full S2T while other calls undergo only word spotting. The output of audio analysis 320 is a text document for each processed audio interaction.

On 324 each text document output by audio analysis 320 and representing an interaction of the corpus undergoes linguistic analysis. Linguistic analysis refers to one or more of the following: Part of Speech (POS) tagging, stemming, and optionally additional processing. In addition, one or more texts, such as e-mails, chat sessions or others can also be passed to linguistic analysis and the following steps.

POS tagging is a process of assigning to one or more words in a text a particular POS such as noun, verb, preposition, etc., from a list of about 60 possible tags in English, based on the word's definition and context. POS tagging provides word sense disambiguation that gives some information about the sense of the word in the context of use.

Word stemming is a process for reducing inflected or sometimes derived words to their base form, for example single form for nouns, present tense for verbs, or the like. The stemmed word may be the written form of the word. In some embodiments, word stems are used for further processing instead of the original word as appearing in the text, in order to gain better generalization.

POS tagging and word stemming can be performed, for example by LinguistxPlatform™ manufactured by SAP AG of Waldorf, Germany,

On rule matching 328, the text output by linguistic analysis 324 is matched against the rules defined on the preparatory stage as output by rule definition 304, optionally involving rule expansion 308 and score setting 312.

It will be appreciated that the matching does not have to be exact but can also be fuzzy. This is particularly important due to the error rate of automatic transcriptions. Fuzzy pattern matching allows for fuzzy search of strings, and may use phonetic similarity between words. For example if the pattern must match the word “cancel”, it can also match the word “council”.

On unification and filtering 332 the extracted entities, relations or events are unified and filtered using their collection-level frequency. Documents or parts thereof which relate to the same patterns may be collected and researched together, and documents or parts thereof which are found to be irrelevant in the corpus-level are ignored. For example, patterns that are very rarely matched, may be ignored and filtered, since the matches may represent a mistake or an event so rare that is not worth exploring.

On visualization 336 the patterns or their matches, including the entities, relations or events are optionally presented to a user, who can also manipulate the results and provide input, such as indicating specific patterns or results as important, clustering interactions in which similar or related patterns are matched, or the like.

The results of rule matching 328 unification and filtering 332, or visualization 336 may be fed back into the preparatory stage of rule creation, i.e., to steps 304, 308 or 312.

Referring now to FIG. 4, showing an exemplary embodiment of an apparatus for information extraction from automatic transcripts, which details components 235, 236, and 240 of FIG. 2, and provides an embodiment for the method of FIG. 3.

The exemplary apparatus comprises communication component 400 which enables communication among other components of the apparatus, and between the apparatus and components of the environment, such as storage 234, logging and capturing component 232, or others. Communication component 400 can be a part of, or interface with any communication system used within the organization or the environment shown in FIG. 2

The apparatus further comprises activity flow manage 404 which manages the data flow and control flow between the components within the apparatus and between the apparatus and the environment.

The apparatus comprises rule definition components 235, audio analysis engines 236 and information extraction components 240.

Rule definition components 235 comprise manual tagging component 412, which lets a user manually tag parts of audio signals as entities, relations, events or the like. Rule generation components 235 further comprise rule definition component 416 which provides a user with a tool for defining the basic rules by constructing patterns consisting of pattern elements and operators, and rule expansion component 420, which expands the basic rules by adding semantic information, for example by using dictionaries, general lexicons, domain-specific lexicons or the like, or syntactic paraphrasing.

Rule definition components 235 further comprise score setting component which lets a user set a score for a word, a phonetic transcription of a word, or a pattern.

Audio analysis engines 236 may comprise any one or more of the engines detailed hereinafter.

Speech to text engine 412 may be any proprietary or third party engine for transcribing an audio into text or a textual representation.

Word spotting engine 416 detects the appearance within the audio of words from a particular list. In some embodiments, after an initial indexing stage, any word can be search for, including words that were unknown at indexing time, such as names of new products, competitors, or others.

Call flow analysis engine 420 analyzes the flow of the interaction, such as number and timing of holds, number of transfers, or the like.

Talk analysis engine 424 analyzes the talking within an interaction: for what part of the interaction does each of the sides speak, silence periods on either side, mutual silence periods, talkover periods, or the like.

Emotion analysis engine 426 analyzes the emotional levels within the interaction: when and at what intensity is emotion detected on either side of an interaction.

It will be appreciated that the components of audio analysis engines 236 may be related to each other, such that results by one engine may affect the way another engine is used. For example, anger words can be spotted in areas in which high emotional levels are detected.

It will also be appreciated that audio analysis engines 236 may further comprise any other engines, including a preprocessing engine for enhancing the audio data, removing silence periods or noisy periods, rejecting audio segments of low quality, post processing engine, or others.

After the interactions had been analyzed by audio analysis engines 236, the output which contains text automatically extracted from interactions is passed to information extraction components 240, which extract information from the text obtained from audio signals, and optionally other textual sources.

Information extraction components 240 comprise Linguistic engine 428 which performs Linguistic Analysis, which may include but is not limited to Part of Speech (POS) tagging, stemming.

After the textual preprocessing by linguistic analysis engine 428, the processed text is passed to rule matching component 432 which also receives the rules as defined by rule definition components 235.

Matching component 432 matches parts of the obtained texts with any of the rules defined by rule definition components 235, using pattern matching. The matches are scored in accordance with the scores assigned to the words, phonetic transcriptions and the pattern.

Once the texts obtained from the interactions and possibly other texts were matched, the matches are input into unification and filtering component 436 which unifies the results and filters them in the corpus level, based on the interaction-level matches.

The results are displayed to a user who can optionally manipulate them, using a user interface component 440, which may enable visualization of manipulation of the results.

The disclosed method and apparatus enable the exploration of audio interactions by automatically extracting texts which match predetermined patterns representing entities, relations and events within the texts.

It will be appreciated by a person skilled in the art that the disclosed method and apparatus are exemplary only and that multiple other implementations and variations of the method and apparatus can be designed without deviating from the disclosure. In particular, different division of functionality into components, and different order of steps may be exercised. It will be further appreciated that components of the apparatus or steps of the method can be implemented using proprietary or commercial products.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for obtaining information from audio interactions associated with an organization, comprising:
receiving a corpus comprising audio interactions;
performing audio analysis on at least one audio interaction of the corpus to obtain at least one text document;
performing linguistic analysis on the at least one text document;
matching the at least one text document with at least one rule to obtain at least one match; and
unifying or filtering the at least one match.

2. The method of claim 1 wherein the at least one rule comprises a pattern containing at least one element.

3. The method of claim 2 wherein the pattern comprise at least one operator.

4. The method of claim 1 further comprising generating the at least one rule.

5. The method of claim 4 wherein generating the at least one rule comprises:
defining the at least one rule;
expanding the at least one rule; and
setting a score for at least one token within the at least one rule or to the at least one rule.

6. The method of claim 1 wherein the audio analysis comprises performing speech to text of the at least one audio interaction.

7. The method of claim 1 wherein the audio analysis comprises at least one item selected from the group consisting of: word spotting of at least one audio interaction; call flow analysis of at least one audio interaction; talk analysis of at least one audio interaction; and emotion detection in at least one audio interaction.

8. The method of claim 1 wherein the linguistic analysis comprises at least one item selected from the group consisting of: part of speech tagging; and word stemming.

9. The method of claim 1 wherein matching the at least one rule comprises assigning a score to each of the at least one match.

10. The method of claim 1 further comprising visualizing the at least one match.

11. The method of claim 1 further comprising capturing the audio interactions.

12. The method of claim 1 wherein matching the at least one rule comprises pattern matching.

13. An apparatus for obtaining information from audio interactions associated with an organization, comprising:
an audio analysis engine for analyzing at least one audio interaction from a corpus and obtaining at least one text document;
a linguistic analysis engine for processing the at least one text document;
a rule matching component for matching the at least one text document with at least one rule to obtain at least one match; and
a unification and filtering component for unifying or filtering the at least one match.

14. The apparatus of claim 13 wherein the audio analysis engines comprise a speech to text engine.

15. The apparatus of claim 13 wherein the audio analysis engines comprise at least one item selected from the group consisting of: a word spotting engine; a call flow analysis engine; a talk analysis engine; and an emotion detection engine.

16. The apparatus of claim 13 wherein the at least one rule comprises a pattern containing at least one element, and at least one operator.

17. The apparatus of claim 13 further comprising rule generation components for generating the at least one rule.

18. The apparatus of claim 17 wherein the rule generation component comprises:
a rule definition component for defining the at least one rule;
a rule expansion component for expanding the at least one rule; and
a score setting component for setting a score for at least one token within the at least one rule or to the at least one rule.

19. The apparatus of claim 13 further comprising a user interface component for visualizing the at least one match.

20. The apparatus of claim 13 further comprising a capturing or logging component for capturing or logging the at least one audio interaction.

21. A computer readable storage medium containing a set of instructions for a general purpose computer, the set of instructions comprising:
receiving a corpus comprising at least one audio interaction associated with an organization;
performing audio analysis on at least one audio interaction of the corpus to obtain at least one text document;
performing linguistic analysis on the at least one text document;
matching the at least one text document with at least one rule to obtain at least one match; and
unifying or filtering the at least one match.
